(19) United States
(12) Patent Application Publication
(10) Pub. No.: US 2008/0129889 A1
(43) Pub. Date: Jun. 5, 2008

(54) Electronic Window System Having Air Conditioner Equipped Thereon, Electronic Window System Using Digital Television and Method for Operating the Same Electronic Window Systems

(76) Inventor: Il Lo Lee, Seoul (KR)

Correspondence Address: BIRCH STEWART KOLASCH & BIRCH, PO BOX 747, FALLS CHURCH, VA, 22040-0747, US

(21) Appl. No.: 11/664,623

(22) PCT Filed: Oct. 5, 2005
(86) PCT No.: PCT/KR05/03291

§ 371 Date: Apr. 4, 2007

(30) Foreign Application Priority Data
Oct. 5, 2004 (KR) 10-2004-0078984

(51) Int. Cl. H04N 5/66

(52) U.S. Cl. 348/739; 348/E05.133

(57) ABSTRACT

An electronic window system having an air conditioner function and an aesthetic function, includes a memory unit storing a back ground picture, .a window picture, and voice data, a control unit generating a synthesized window background picture by synthesizing the background picture and the window picture and outputting control variables corresponding to the synthesized window background picture, a video output unit displaying the synthesized window background picture, a voice output unit, an air conditioner unit, and a main menu unit, wherein the control unit establishes the option environment mode by combining the background picture, the window picture, the control variable and the voice data to control operations of the above units.

### TECHNICAL FIELD

The present invention relates to an electronic window (e-window), and more particularly, to an electronic window system and operating method thereof for combining an air conditioner and a display device together to change physical and visual environments suitable for a variation of a peripheral environment such as season and weather to be provided to a user. And, the present invention relates to an electronic window system and operating method thereof capable of performing a display or sound function of the electronic window system using a general digital television.

### BACKGROUND ART

Generally, spaces isolated from their external circumstances and located in huge and complicated buildings have been rapidly developed in the modern society.

The over-crowdedness into the downtown area severely pollutes the air, and an indoor life space of a building tends to be further closed not only for the air conditioning of the room temperature but also for blocking the polluted external air.

People, who stay or work within such a closed space, feel stuffy and isolated such that their working efficiency may be decreased. And, the closed space negatively affects the people'S emotion. To solve such a problem, various methods have been used.

For instance, to enhance efficiency of working within such a closed space as an office room, a conference room and the like within a large-scale building, various aesthetic or physical methods are used in a manner that a landscape painting or a flowerpot are provided within the closed space or that an air conditioner is driven.

Concern and public interest for well-being home appliances rises to keep up with the trend, whereby the consumptions of air cleaner, phytoncide shower device and the like have been considerably increased.

However, the individually-provided various home appliances or alternatives according to necessity are basically insufficient to relieve the living people from the fatigue, stuffiness and the like in the closed space.

### DISCLOSURE

### Technical Problem

However, the individually-provided various home appliances or alternatives according to necessity are basically insufficient to relieve the living people from the fatigue, stuffiness and the like in the closed space.

### TECHNICAL SOLUTION

An object of the present invention is to improve the indoor environment that physically and visually brings fatigue or stuffiness into a closed indoor living space. In particular, an object of the present invention is to provide a technology that physically improves not only an indoor air condition using an air conditioner but also a visual environment using a variable display system based on season, temperature, weather, surrounding scene and the like.

To achieve these objects, there is provided an electronic window system, which has an air conditioner function and an aesthetic function, according to the present invention, includes a memory unit storing a back ground picture configuring a background outside a virtual window, a window picture configuring a virtual window frame, and voice data corresponding to the background picture, a control unit generating a synthesized window background picture by synthesizing the background picture and the window picture stored in the memory unit together and outputting control variables corresponding to the synthesized window background picture, a video output unit displaying the synthesized window background picture synthesized by the control unit, a voice output unit outputting the voice data stored in the memory unit by a control of the control unit, an air conditioner unit operating based on the control variable outputted from the control unit, and a main menu unit having an option environment mode providing an environment enabling a user to select the background picture, the window picture and the control variable, wherein the control unit establishes the option environment mode by combining the background picture, the window picture, the control variable and the voice data to control operations of the memory unit, the video output unit, the voice output unit, the air conditioner unit and the main menu unit.

Preferably, the background picture is stored as inner contents in the memory unit.

Preferably, the electronic window system further includes a camera module externally photographing the background picture to transmit. More preferably, the background picture is displayed on the video output unit together with the window picture as real-time moving pictures. Preferably, the control variables of the window picture, the voice data and the air conditioner unit can be respectively selected for the background picture transmitted by real time.

Preferably, the control variables include wind-direction, wind speed, temperature and humidity.

Preferably, in case of using the background picture not supported in the option environment mode, the main menu unit further includes a user defining mode in which a user selects the control variables of the window picture, the voice data and the air conditioner unit.

Preferably, the main menu unit is selected by a remote controller.

To further achieve these and other advantages and in accordance with the purpose of the present invention, an electronic window system, which includes a digital television (DTV) providing an aesthetic function and has an air conditioner function, includes a memory unit storing a back ground picture configuring a background outside a virtual window, a window picture configuring a virtual window frame, and voice data corresponding to the background picture, a control unit generating a synthesized window background picture by synthesizing the background picture and the window picture stored in the memory unit together and outputting control variables corresponding to the synthesized window background picture, an air conditioner unit operating based on the control variables outputted from the control unit, and a main menu unit having an option environment mode providing an environment enabling a user to select the background picture, the window picture and the control variable, wherein the digital television displays a synthesized window background picture synthesized by the control unit and outputting voice data stored in the memory unit, wherein the control unit establishes the option environment mode by combining the background picture, the window picture, the control variable and the voice data to control operations of the memory unit, the video output unit, the voice output unit, the air conditioner unit, the main menu unit and the digital television.

To further achieve these and other advantages and in accordance with the purpose of the present invention, a method of operating an electronic window system, which includes an air conditioner function and a display function, includes a step (a) of executing an electronic window (e-window) mode, a step (b) of selecting an option environment mode to be used as the electronic window, a step (c) of acquiring a background picture from an external camera or a stored background picture according to the option environment mode, a step of forming a synthesized window background picture by synthesizing the acquired background picture with a window picture previously stored in a memory unit of the electronic window system, a step of driving an air conditioner according to air conditioner control variables per the option environment mode for the synthesized window background picture, and outputting the synthesized window background picture and a corresponding sound.

### ADVANTAGEOUS EFFECTS

Thus, the present invention implements an electronic window (e-window) system playing roles of external scene presentation, temperature adjustment, humidity adjustment, ventilation and the like, thereby enhancing working environment or normal living environment by providing a pleasant environment close to nature within a closed living space.

In particular, the present invention combines such a display device as DTV with an air conditioner, which is provided or applied to most homes and offices, thereby enabling an efficient arrangement of space and thereby bringing about an interior effect.

And, the present invention provides a user environment mode configured with various combined control variables, thereby facilitating a user to use the electronic window without manipulating various variables in detail. Moreover, the present invention enables a user to watch external real pictures without feeling isolated, thereby enhancing working efficiency. And, the present invention uses the digital television as an interior article, thereby raising resource utilization as well as bring about an aesthetic effect.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram of an electronic window system combined with an air conditioner according to one embodiment of the present invention;

FIG. 2 is a diagram of a concrete example of a user input algorithm applied to an electronic window according to the present invention;

FIG. 3 is a flowchart of a control method of an air conditioner unit in an operating method of an electronic window according to the present invention;

FIG. 4 is a schematic block diagram of an air conditioner and a digital television system according to another embodiment of the present invention;

FIG. 5 is a flowchart of an electronic window algorithm of an electronic window system according to the present invention; and

FIG. 6 is a flowchart of an electronic window system using an air conditioner and a digital television according to a further embodiment of the present invention.

### BEST MODE

Reference will now be made in detail to the preferred embodiments of the present invention, examples of which are illustrated in the accompanying drawings.

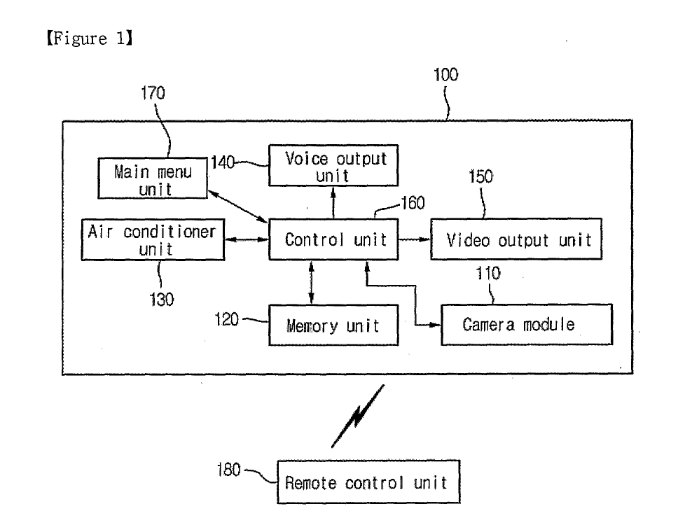

FIG. 1 is a schematic block diagram of an electronic window system 100 according to a first embodiment of the present invention.

Referring to FIG. 1, an electronic window system 100 according to the present invention includes an air conditioner unit 130, a voice output unit 140, a video output unit 150, a camera module 110, a memory unit 120, a control unit 160, a main menu unit 170 providing user options, and a remote control unit 180 such as a remote controller that controls an operation of the electronic window system 100 remotely.

The camera module 110 is externally provided to photograph real background pictures to transmit to the video output unit 150 or the memory unit 120. The real background pictures used in the specification (hereinafter, all pictures) indicates still pictures or moving pictures. The memory unit 120 stores the real background pictures transmitted from the camera module 110, various window pictures such as a window frame, a curtain and the like, and various voice data.

The background pictures, window pictures and voice data stored in the memory unit 120 can be stored in a manner of being appropriately combined together according to preset user environment modes.

In particular, the user environment modes include several kinds of modes that are generated from the combination of the most possible environments based on external background factors remarkably felt in real life by a user via a window. The external background factors include for example, peripheral scenes according to seasons, changes of natural environments, changes of natural phenomena appearing according to weather variations, and a site at which a building is located.

In addition to the user environment modes mentioned above, the system may provide user-defining mode through which the user is allowed to adjust a site, season, weather, window, temperature, wind direction, wind speed, humidity and the like based on background pictures which are not supported by the user environment mode and which are derived from not-user-surroundings and stored previously in the memory unit.

The video output unit 150 displays the real time and real background pictures transmitted via the camera module 110, the real background pictures transmitted from the memory unit 120, or the electronic window background pictures combined with the window pictures.

The voice output unit 140 outputs sounds suitable for the electronic window background pictures of the video output unit 150 via a speaker. The air conditioner unit 130 forms an indoor environment suitable for the electronic window background pictures by adjusting a wind direction, wind speed, temperature, humidity and the like according to the user environment mode or user-defining mode.

The control unit 160 collectively controls the camera module 110, the memory unit 120, the video output unit 150, the voice output unit 140 and the air conditioner unit 130 and controls the voice and video output units 140 and 150 to output the electronic window background pictures and voice data according to the set user environment mode or user-defining mode, respectively.

Operational algorithm of the electronic window system according to the present invention is mainly divided into three parts, which is explained with reference to the attached drawings as follows.

It is the algorithm for receiving variables including a season, weather, window type and the like selected by a user. In this case, assuming that the display unit corresponds to a window, a window picture corresponds to a type of a virtual window frame, a type of a virtual curtain decorated together with the virtual window frame and the like. And, they are stored in the memory unit 120 of the electronic window system 100. Each of the variables is stored in a form of the user environment mode, which is used as an input variable in generating an electronic window background picture from combining a window picture and a background picture selected by a user together.

Secondly, it is the algorithm for combining external real background pictures transmitted from the external camera module with the window picture stored in the memory or for combining the back ground picture and the window picture stored in the memory together according to the user environment mode. The background picture corresponds to a virtual scene viewed via a virtual window or a picture when a substantially photographed moving picture or still picture appears via the virtual window. The virtual background picture is previously stored in the memory unit 120 and the real background picture is selectively stored in the memory unit 120 according to a user'S taste. Hence, the virtual background picture or the real background picture can be edited into a virtual background picture to be used later.

Thirdly, it is the algorithm for controlling wind direction, wind speed, temperature and humidity of the air conditioner by receiving the user environment mode from an LUT (lookup table) stored in the memory.

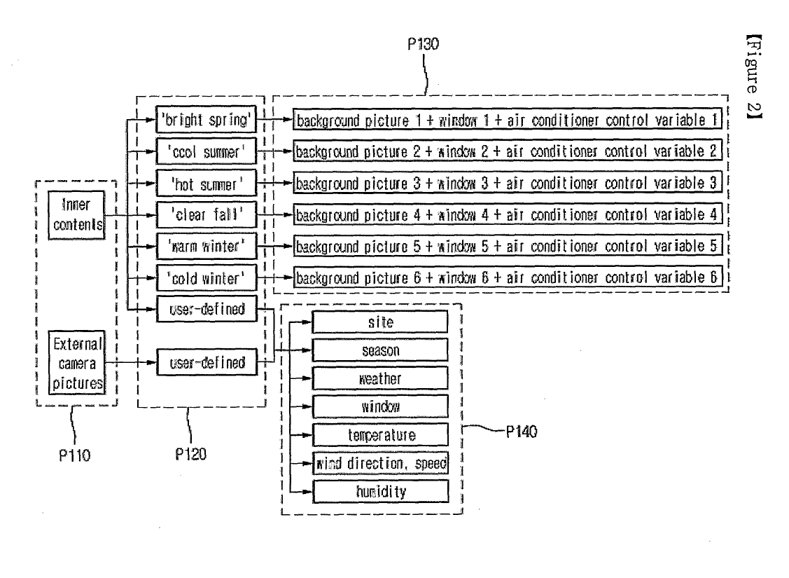

FIG. 2 shows an example of a user input algorithm of an electronic window according to the present invention, in which a configuration of the main menu unit 170 in FIG. 1 is shown. The menu unit 170 includes a video source unit P110 deciding whether to obtain a video source from inner contents or from a real picture of an external camera, a mode selection unit P120 enabling a prescribed environment mode previously stored in a memory as inner contents to be provided, an option environment mode variable unit P130 presenting a control variable of the mode selection unit, and a user-defining mode variable unit P140 providing a selection environment enabling a user to directly combine the environment mode to be set. And, the user selection input is preferably performed via the remote control unit 180 such as a remote controller.

Referring to FIG. 2, first of all, a user decides whether to use a background picture (‘background pictures 1 to 6’ of the option environment mode variable unit P130 respectively corresponding to ‘bright spring, cool summer, hot summer, clear fall, warm winter and cold winter’? of the option environment mode unit P120 in the drawing) of inner contents stored in a memory as an electronic window background picture of the video source unit P110 or to use an external building background picture (‘external camera picture’? determined by a user via ‘user definition’? in the drawing) photographed by an external camera in real time as the electronic window background picture.

An option environment mode is set for the inner contents.

The option environment modes (corresponding to ‘bright spring, cool summer, hot summer, clear fall, warm winter and cold winter’? in the drawing) are established by combining the most possible environments together by considering that external background factors remarkably felt in real life by a user via a window include peripheral scenes according to seasons, changes of natural environments, changes of natural phenomena appearing according to weather variations, and a site at which a building is located. In case of using background pictures which are not supported by the user environment modes but supported by the user-defining mode, the system allows the user to adjust a site, season, weather, window, temperature, wind direction, wind speed, humidity and the like contained in the user-defining mode variable unit P140.

First of all, in the option environment modes, ‘bright spring’, ‘cool summer’, ‘hot summer’, ‘clear fall’, ‘warm winter’ and ‘cold winter’? modes are set to [background picture 1+window 1+air conditioner control variable 1], [background picture 2+window 2+air conditioner control variable 2], [background picture 3+window 3+air conditioner control variable 3], [background picture 4+window 4+air conditioner control variable 4], [background picture 5+window 5+air conditioner control variable 5] and [background picture 6+window 6+air conditioner control variable 6], respectively.

The background pictures 1-to-6 are stored in the memory unit 120 and the windows 1 to 6 are stored in the memory unit 120 as well. And, the temperature, wind direction, wind speed and humidity suitable for the environment mode are set to the air conditioner control variables 1 to 6.

For the user-defining mode, the electronic window background picture can be outputted using the input variables stored in the inner contents such as a site, season, weather, window, temperature, wind direction, wind speed and humidity.

In case that a user attempts to use the external building picture acquired from the external camera as the electronic window background picture, it is switched to the user-defining mode so that the indoor environment can be adjusted together with the electronic window background picture by controlling the variables of the site, season, weather, window, temperature, wind direction, wind speed and humidity.

Thus, the selected user input finally configures one background picture mode, window frame and curtain picture mode and is mapped to the background picture and the window picture stored in the memory unit one by one.

And, each background picture defined appropriate air conditioner control variables, i.e., wind direction, wind speed, temperature and humidity, whereby the user input is used as a control input of the air conditioner unit as soon as the setup of the background picture.

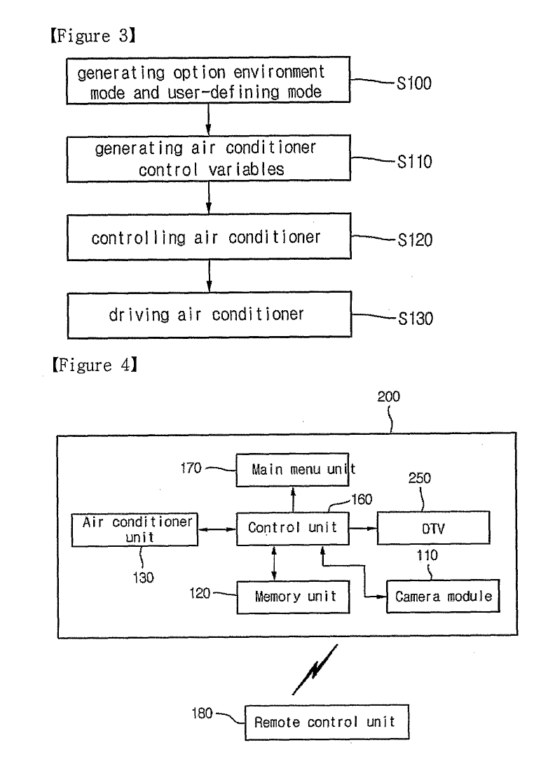

FIG. 3 is a flowchart of an operating method of a digital television system according to the present invention, in which a control method of an air conditioner unit is shown.

First of all, as mentioned in the foregoing description, the background picture of the electronic window corresponds to the real-time pictures outside the building transmitted from the camera module 110 by the user or the inner contents stored in the memory unit 120.

The above-explained background picture is selected by the user's input.

And, the window picture is opaquely overlapped with the background picture to configure the electronic window background picture of the electronic window. An operational algorithm of the air conditioner unit 130 of the electronic window system according to the present invention is explained with reference to FIG. 3 as follows.

First of all, a specific environment mode or a user-defining mode is generated by a user's selection in the mode selection unit P120 (S100). Control variables such as a wind direction, wind speed, temperature and humidity set or selected according to the option environment mode or the user-defining mode are generated from the option environment mode variable unit P130 or the user-defining mode variable unit P140 to be paged (S110). The air conditioner unit 130 is controlled by the control unit 160 according to the control variables (S120). As a result, the air conditioner unit 130 is driven together with the electronic window background picture (S130).

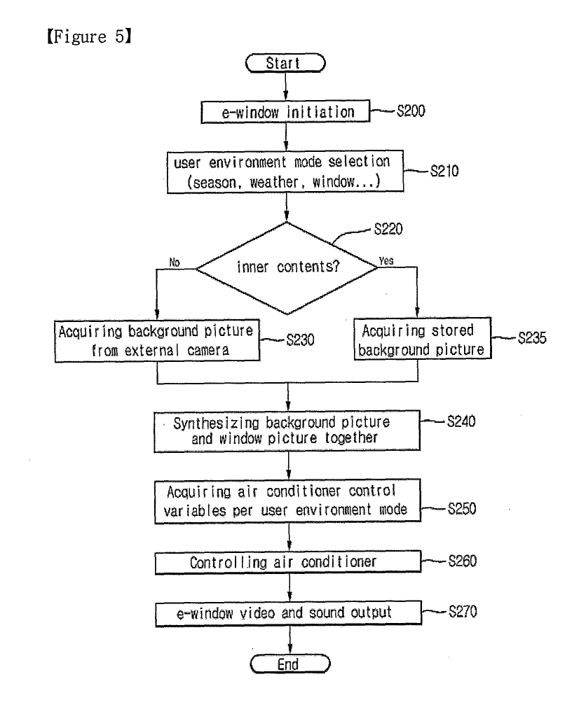

FIG. 5 is a flowchart of an electronic window algorithm of an electronic window system according to a first embodiment of the present invention.

First of all, the electronic window system is activated if a user turns on power using the remote control unit 180 such as a remote controller. An input mode of the electronic window (e-window) is then initiated (S200). The option environment mode such as the site, season, weather, window, temperature, wind direction, wind speed and humidity us selected in the mode selection unit P120 of the main menu unit 170 (S210).

It is then decided whether to use the inner contents (S235) or the real-time background picture acquired from the external camera (S230) as the background picture to be displayed via the video output unit 150 of the electronic window system 100. And, it is decided what kind of sound will be used (S220).

The control unit 160 synthesizes the background picture stored in the inner contents and the background picture acquired from the external camera with the window picture stored in the memory unit 120 (S240).

In doing so, the window picture such as a window frame and a curtain is opaquely synthesized with the background picture.

Subsequently, air conditioner control variables per the option environment mode are acquired from the option environment mode variable unit P130 (S250).

The control unit 160 then drives the air conditioner unit 130 based on the acquired control variables (S260).

Finally, the electronic window background picture generated from synthesizing the background picture and the window picture together and the sound are outputted (S270).

By the above explained configuration and operation, it is able to provide the technology that can enhance the physical and aesthetic conditions of the closed internal indoor environment.

### MODE FOR INVENTION

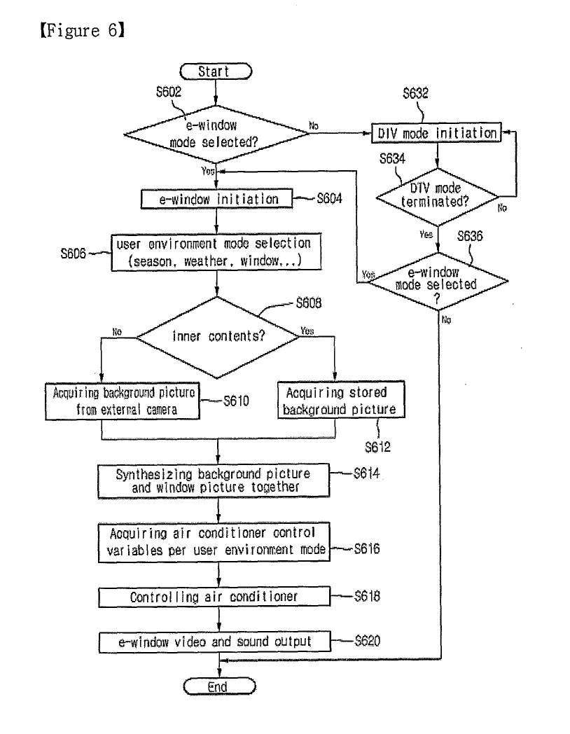

A configuration and operation of an electronic window system according to a second embodiment of the present invention are explained with reference to FIG. 5 and FIG. 6 as follows. In the configuration shown in FIG. 5, elements overlapped with those of the configuration according to the first embodiment of the present invention in FIG. 1 use the same reference numbers and their explanation will be skipped for simplification.

Compared to the electronic window system according to the first embodiment, an electronic window system according to a second embodiment has the same configuration of that of FIG. 1 except that the video output unit 150 and the voice output unit 140 in FIG. 1 are replaced by a general digital television (DTV) used in an indoor environment. Namely, the configurations of the first and second embodiments are identical but differ from each other in that display and sound devices of the DTV are used as a video output unit and a voice output unit in FIG. 5, respectively.

In case of such a configuration, the general DTV can be used as it is.

And, the general DTV can be used as the electronic window, which is preferable in aspect of efficient resource use.

Hence, an operation of the flowchart shown in FIG. 6 is completely identical to that of the flowchart shown in FIG. 4 except the additional DTV-associated operation part.

Referring to FIG. 6, first of all, it is decided whether to select an electronic window mode or to initiate a DTV mode (S602). If the electronic window mode is initiated, steps S604 to S620 (coincide with the steps S210 to S270 in FIG. 4) are executed. Otherwise, the DTV mode is initiated (S632). In case of terminating the DTV mode (S634), it is decided whether to select the electronic window mode (S636). If the electronic window mode is selected, a process including the steps S604 to S620 is initiated. Otherwise, the process is ended.

In this case, the operation and effect are identical to those of the first embodiment. And, it is advantageous in reduction of installation cost since the display and sound devices need not to be additionally installed. While the present invention has been described and illustrated herein with reference to the preferred embodiments thereof, it will be apparent to those skilled in the art that various modifications and variations can be made therein without departing from the spirit and scope of the invention. For instance, even if the display device and the control unit of the electronic window system are connected together by wire, the corresponding elements can be connected together by wireless. In particular, the control unit of the electronic window system and the DTV can be separated from each other by being connected together by wireless. And, the user input means can be configured by wire instead of including the remote control unit such as the remote controller and the like. Thus, it is intended that the present invention cover the modifications and variations of this invention that come within the scope of the appended claims and their equivalents.

### INDUSTRIAL APPLICABILITY

Accordingly, the present invention is applicable to any workspace or living environment space that needs an environment-friendly effect physically and aesthetically in the closed space having difficulty in accessing the natural environment relatively.

1. An electronic window system, which has an air conditioner function and an aesthetic function, the electronic window system comprising:
a memory unit storing a background picture configuring a background outside a virtual window, a window picture configuring a virtual window frame, and voice data corresponding to the background picture;
a control unit generating a synthesized window background picture by synthesizing the background picture and the window picture stored in the memory unit together and outputting control variables corresponding to the synthesized window background picture;
a video output unit displaying the synthesized window background picture synthesized by the control unit;
a voice output unit outputting the voice data stored in the memory unit by a control of the control unit;
an air conditioner unit operating based on the control variable outputted from the control unit; and
a main menu unit having an option environment mode providing an environment enabling a user to select the background picture, the window picture and the control variable,
wherein the control unit establishes the option environment mode by combining the background picture, the window picture, the control variable and the voice data to control operations of the memory unit, the video output unit, the voice output unit, the air conditioner unit and the main menu unit.

2. The electronic window system of claim 1, wherein the background picture is stored as inner contents in the memory unit.

3. The electronic window system of claim 1, further comprising a camera module externally photographing the background picture to transmit.

4. The electronic window system of claim 3, wherein the background picture is displayed on the video output unit together with the window picture as real-time moving pictures.

5. The electronic window system of claim 4, wherein the control variables of the window picture, the voice data and the air conditioner unit can be respectively selected for the background picture-transmitted by real time.

6. The electronic window system of claim 1, wherein the control variables include wind direction, wind speed, temperature and humidity.

7. The electronic window system of claim 1, wherein in case of using the background picture which are not supported in the option environment mode, the main menu unit further includes a user-defining mode in which a user selects the control variables of the window picture, the voice data and the air conditioner unit.

9. An electronic window system, which includes a digital television (DTV) providing an aesthetic function and has an air conditioner function, the electronic window system comprising:
a memory unit storing a background picture configuring a background outside a virtual window, a window picture configuring a virtual window frame, and voice data corresponding to the background picture;
a control unit generating a synthesized window background picture by synthesizing the background picture and the window picture stored in the memory unit together and outputting control variables corresponding to the synthesized window background picture;
an air conditioner unit operating based on the control variables outputted from the control unit; and
a main menu unit having an option environment mode providing an environment enabling a user to select the background picture, the window picture and the control variable,
wherein the digital television displays a synthesized window background picture synthesized by the control unit and outputting voice data stored in the memory unit,
wherein the control unit establishes the option environment mode by combining the background picture, the window picture, the control variable and the voice data to control operations of the memory unit, the video output unit, the voice output unit, the air conditioner unit, the main menu unit and the digital television.

10. The electronic window system of claim 9, wherein the background picture is stored as inner contents in the memory unit.

11. The electronic window system of claim 9, further comprising a camera module externally photographing the background picture to transmit.

12. The electronic window system of claim 11, wherein the background picture is displayed on the video output unit together with the window picture as real-time moving pictures.

13. The electronic window system of claim 12, wherein the control variables of the window picture, the voice data and the air conditioner unit can be respectively selected for the background picture transmitted by real time.

14. The electronic window system of claim 9, wherein the control variables include wind direction, wind speed, temperature and humidity.

15. The electronic window system of claim 9, wherein in case of using the background picture which are not supported in the option environment mode, the main menu unit further includes a user-defining mode in which a user selects the control variables of the window picture, the voice data and the air conditioner unit.

16. The electronic window system of claim 9, wherein the main menu unit is selected by a remote controller.

17. A method of operating an electronic window system, which includes an air conditioner function and a display function, the method comprising:
a step (a) of executing an electronic window (e-window) mode;
a step (b) of selecting an option environment mode to be used as the electronic window;
a step (c) of acquiring a background picture from an external camera or
a stored background picture according to the option environment mode;
a step of forming a synthesized window background picture by synthesizing the acquired background picture with a window picture previously stored in a memory unit of the electronic window system;
a step of driving an air conditioner according to air conditioner control variables per the option environment mode for the synthesized window background picture; and
outputting the synthesized window background picture and a corresponding sound.

18. The method of claim 17, wherein the option environment mode is established by combining season, weather, window, wind direction, wind speed, temperature, humidity and sound.

19. The method of claim 17, wherein in case of using the background picture not supported in the option mode, the control variables of the synthesized window picture data, voice data and the air conditioner can be selected.

20. The method of claim 17, wherein the control variables include wind direction, wind speed, temperature and humidity.

21. The method of claim 17, wherein the background picture is displayed to a video output unit of the electronic window system together with the window picture by real-time moving pictures.

22. The method of claim 17, wherein the display function is performed via a dedicated display device for displaying the synthesized window background picture.

23. The method of claim 17, wherein the display function and a function of outputting the sound are performed through the digital television.
